(19) United States
(12) Patent Application Publication
(10) Pub. No.: US 2024/0029143 A1
(43) Pub. Date: Jan. 25, 2024

(54) Item-Based Payment Processing System

(71) Applicant: Toshiba Global Commerce Solutions Holdings Corporation, Tokyo (JP)

(72) Inventors: Brad M. Johnson, Raleigh, NC (US); Adrian Rodriguez, Durham, NC (US); Susan W. Brosnan, Raleigh, NC (US)

(21) Appl. No.: 17/868,921

(22) Filed: Jul. 20, 2022

(51) Int. Cl. G06Q 30/06; G06Q 20/26

(52) U.S. Cl. CPC G06Q 30/0635; G06Q 30/0639; G06Q 20/26

(57) ABSTRACT

A digital image analysis is performed on one or more images of a user interacting with an item in a retail store. Based on a result of the digital image analysis, a computer determines whether the user has effectively removed the item from availability for purchase by others. If so, the computer automatically initiates an electronic transaction debiting a financial account of the user for a cost of the item prior to the user checking out of the store. If not, the computer delays initiating the electronic transaction until the user checks out of the retail store.

### BACKGROUND

Retail stores have been evolving into more than simply a place to shop. For example, many stores now enhance a customer's “shopping experience” by adding a variety of conveniences such as “grab-n-go” items, food courts, restaurants, and “stores-within-stores.” For example, some stores will provide their customers with various sample items (e.g., a food or a drink) to snack on as they shop. Other stores provide a seating area, such as a bar, where adults can sit and enjoy different beverages and snacks while their significant others shop. Increasingly, though, customers do not want to stand in line to pay for the items they want to purchase.

### BRIEF DESCRIPTION OF THE DRAWINGS

FIG. 1 is block diagram illustrating a communications system for a retail environment configured according to one embodiment of the present disclosure.

FIG. 2 illustrates an interior of a retail store configured to automatically initiate an electronic transaction charging retail customers for items that they have effectively removed from availability for purchase by others, according to one embodiment of the present disclosure.

FIG. 3 is a flow diagram illustrating a method for initiating an electronic transaction for an item that a customer has effectively removed from availability for purchase by others, according to one embodiment of the present disclosure.

FIG. 4 is a flow diagram illustrating a method for initiating an electronic transaction for an item that a customer has effectively removed from availability for purchase by others, based on a detected trigger event, according to one embodiment of the present disclosure.

FIG. 5 is a flow diagram illustrating a method for obtaining the information required to initiate an electronic transaction for an item that a customer has effectively removed from availability for purchase by others, according to one embodiment of the present disclosure.

FIG. 6 is schematic block diagram illustrating some component parts of a computing device configured to initiate an electronic transaction for an item that a customer has effectively removed from availability for purchase by others, according to one embodiment of the present disclosure.

FIG. 7 is a schematic block diagram of a computer program product that configures a computing device to initiate an electronic transaction for an item that a customer has effectively removed from availability for purchase by others, according to one embodiment of the present disclosure.

### DETAILED DESCRIPTION

Embodiments of the present disclosure configure a computing device, operating in a retail context, to automatically initiate an electronic transaction debiting a financial account of a customer for the cost of an item the customer has effectively removed from availability for purchase by others, prior to the customer checking out of the retail store. Initiating the transaction, however, is selective. That is, not all items selected by the customer for purchase will trigger automatically initiating the transaction prior to check out. Rather, for some items, initiating an electronic transaction to debit the customer's financial account is intentionally delayed until the customer checks out of the retail store.

Computing devices configured to operate according to the present embodiments provide benefits and advantages that conventionally configured computing devices cannot provide. For example, as stated above, customers do not typically want to stand in line at a point-of-sale (POS) station to check out. This is because many customers find that standing in line “takes too long.” Even when a store provides multiple POS stations at different areas, the time spent by the customer standing in line and checking out increases dramatically. Therefore, many retail stores enhance the shopping experience for their customers by adding a convenience such as “grab-n-go” for the customer. With “grab-n-go,” the customer needs only to grab one or more selected items from a shelf in the store (e.g., a pre-made sandwich). The customer can then leave the store without stopping to pay for the items at a conventional POS station to check out. This is because charging the customer's financial account for the item is initiated responsive to the customer exiting the store.

However, while such concepts are beneficial to customers, they can be problematic for the retailer. By way of example only, the cameras positioned at conventional POS stations may not capture everything that goes on within a store prior to check out. For example, the cameras may not detect a customer opening and at least partially consuming an item while the customer is actively shopping. Thus, if the customer does not exit the store with the opened item, the customer may not be charged for that item.

The present embodiments address such situations by configuring a computing device to selectively determine whether a customer should be automatically charged for an item prior to check out on a per-item basis. Particularly, one embodiment of the present disclosure utilizes frictionless camera technology to detect where a customer is within the retail store, what particular item(s) the customers are interacting with, and how they are interacting with those items. If the computing device determines that the customer has effectively removed the item from availability for purchase by others, the computing device automatically initiates an electronic transaction to debit the customer's financial account for the cost of the item. Otherwise, the computing device delays initiating the electronic transaction for the item until the customer reaches a conventional POS station.

As used herein, a customer effectively removes an item from availability for purchase by others when the customer alters the item or its packaging to such an extent that the retailer cannot immediately place the item back into circulation for purchase by other customers. Additionally, a customer effectively removes an item from availability for purchase by others when the item is taken from a one or more predefined areas of a store or is of a predetermined type. By way of example only, a customer may be considered to have effectively removed an item from availability for purchase by others if the item is a consumable item such as a salad from a salad bar, coffee, a sandwich from a deli section of a store, or a baked good from a bakery. Additionally, a customer is considered to have effectively removed an item from availability for purchase by others when the item is a high-cost item (e.g., jewelry), or an item that is easily stolen (e.g., small, easily concealable items like lipstick), or similar item. Note, however, that effectively removing an item from availability for purchase by others does not necessarily mean that the customer cannot subsequently return the item to the retailer for a full or partial refund.

For example, consider an apple. A customer who bites into the apple prior to check out (e.g., while still in the produce section) has effectively altered the state of the apple such that it can no longer be sold to other customers. In another example, consider a pack of batteries. A customer who opens the pack prior to check out has also effectively altered the state of the packaging such that retailer can no longer sell the package of batteries to other customers without first securing the packaging. In yet another example, consider a customer who takes a baked good from a bakery or creates a plate of hot and/or cold food (e.g., a salad, soup, sandwich, etc.), selects a small, easily concealable item, or behaves in an odd manner after selecting an item from a shelf in the store. In each case, the computing device performs a digital image analysis of the customer interacting with the item, and is then controlled, based on the results of the digital image analysis, to automatically initiate the electronic transaction to debit the customer's account for the cost of the item prior to the customer reaching the conventional POS stations. Otherwise, the computing device delays initiating the electronic transaction for the items until the customer reaches a conventional POS station. If, however, the customer is not satisfied with the item, the customer can always return the item for a refund according to current store policies.

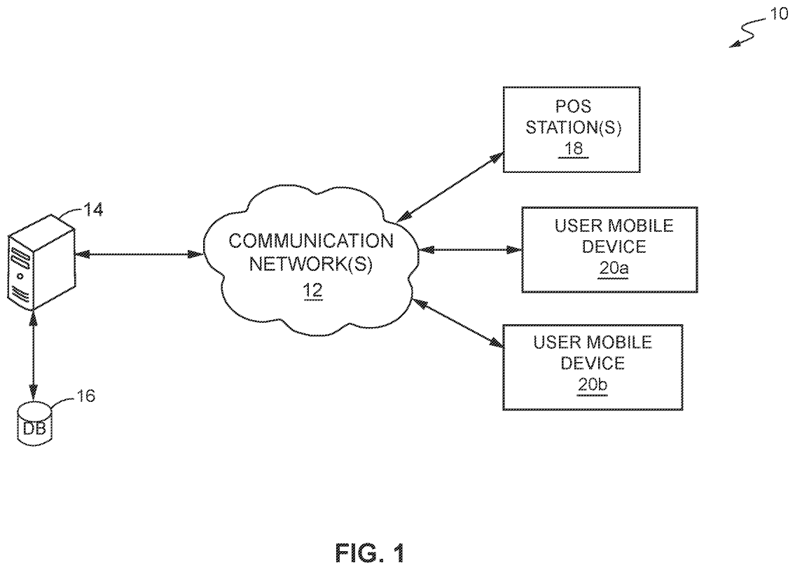

Turning now to the drawings, FIG. 1 illustrates a communications system 10 for a retail environment configured according to one embodiment of the present disclosure. In the embodiment of FIG. 1, system 10 is illustrated and described in the context of a computer system for a retail business (e.g., HARRIS TEETER, WALMART, HOME DEPOT, TARGET, COSTCO, etc.), and functions to provide Point-of-Service (POS) solutions to the customers of these businesses. However, those of ordinary skill in the art should readily appreciate that the discussion of system 10 in a retail context is merely for illustrative purposes and ease of discussion.

As seen in FIG. 1, system 10 comprises one or more communications networks 12 communicatively interconnecting a computing device 14 (e.g., an application server—AS) to POS station(s) 18 and one or more user mobile devices 20a, 20b (collectively referred to herein as “mobile devices 20”). A database (DB) 16 or other mass storage device may also be connected to AS 14 and is configured to store information and data generated for, and utilized by, system 10. As described in more detail below, such data may include, but is not limited to, information that identifies the customers of the retail store associated with system 10 and their financial accounts at one or more financial institutions.

Communications network 12 may comprise one or more public and/or private data networks that use, for example, the Internet Protocol (IP) to communicate data packets between components. Such networks are well-known in the art and include networks that are globally accessible by users (e.g., the Internet), as well as Local Area Networks (LANs), Wide Area Networks (WANs), and enterprise networks. In some cases, communications network 12 may comprise one or more wireline networks (e.g., ETHERNET). In other cases, communications network 12 may comprise one or more wireless networks in addition to, or in lieu of, one or more wireline networks.

AS 14 comprises one or more computer servers accessible by the POS station(s) 18 via communications network 12. In general, AS 14 provides centralized processing services to the POS station(s) 18. Such services may include, but are not limited to, data processing services (e.g., processing data according to one or more predefined business-context rules), provisioning services (e.g., for provisioning the POS station(s) 18 and/or other devices not specifically seen in FIG. 1 with default/updated rule sets, data, and configuration settings), and verification/authorization services (e.g., username/password verification, payment authorization, customer identification, etc).

As described in more detail later, AS 14 is configured according to the present embodiments to perform a digital image analysis on one or more images of a customer interacting with an item in a retail store. Then, based on the results of the analysis, AS 14 determines whether the customer has removed the item from availability for purchase by others. If AS 14 determines that the customer has removed the item from availability for purchase by others, AS 14 automatically initiates an electronic transaction that debits a financial account of the customer for a cost of the item before the customer checks out of the store. Otherwise, AS 14 delays initiating the electronic transaction until the customer checks out of the retail store. To accomplish these functions, AS 14 may be in communication with a mobile device 20 of the customer.

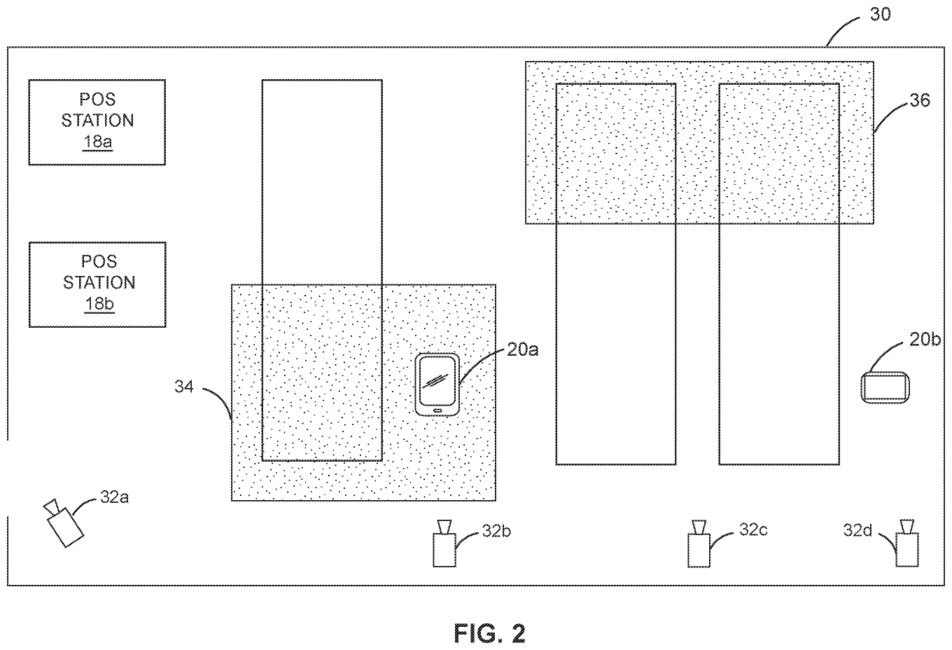

In more detail, FIG. 2 illustrates a hypothetical interior layout of an example retail store 30 having system 10 according to one embodiment. In FIG. 2, store 30 comprises a plurality of POS stations 18a, 18b and a plurality of cameras 32a, 32b, 32c, 32d (collectively referred to herein as “cameras 32”) disposed throughout store 30. Such cameras 32 may be visible to the customers, hidden or disguised from customers (e.g., closed-circuit cameras), or a combination of both. Regardless, cameras 32 are configured to detect and track the customers as they move through store 30, capture digital images of the customers as they interact with the various items offered by store 30 (e.g., place a selected item into a cart, open the packaging of an item, consume an item, etc.), and communicate those captured digital images to AS 14 for analysis. AS 14, in turn, performs a digital image analysis on the images and determines, based on that analysis, whether the customer has removed the item from availability for purchase by others. If so, AS 14 automatically initiates an electronic transaction that debits a financial account of the customer for a cost of the item before the customer checks out of the store. If not, AS 14 delays initiating the electronic transaction until the customer checks out of the retail store.

It should be noted that the present embodiments are not limited to automatically initiating the electronic transaction based on the results of the digital image analysis. In other embodiments, for example, AS 14 is configured to automatically initiate the electronic transaction responsive to detecting a predetermined event trigger.

For example, as seen in FIG. 2, store 30 may be partitioned into a plurality of zones 34, 36. Each zone 34, 36 comprises a plurality of different items available for purchase by the customer and is designated as being one of a preauthorized charging zone (e.g., zone 34) and a non-preauthorized charging zone (e.g., zone 36). Based on the results of the digital image analysis performed on the images captured by cameras 32 (and/or by the determined location of the customer's mobile device 20a, 20b relative to zones 34, 36), AS 14 determines when the customer enters and exits a zone 34, 36. Responsive to detecting that the customer has selected an item from the preauthorized charging zone 34, AS 14 automatically initiates the electronic transaction to debit the financial account of the customer for the cost of the item. However, responsive to detecting that the customer has selected an item from a non-preauthorized charging zone 36, AS 14 will delay initiating the electronic transaction until the customer checks out of store 30.

In situations where the customer and their financial details are known to the store 30, AS 14 can automatically initiate the financial transaction to debit the customer's financial account for the cost of the item, as previously described. However, in situations where the customer and/or their financial details are not known to store 30, AS 14 automatically generates and sends a message to the customer's device (e.g., mobile device 20b via network 12) requesting that the customer authorize the automatic electronic transaction. In these cases, the customer would be required to provide an indication (e.g., via a user interface on mobile device 20b) explicitly authorizing AS 14 to debit the financial account of the customer. If the customer neglects to authorize the transaction, AS 14 could then generate and send a message to a store operator (e.g., security personnel), thereby initiating an audit of the customer's cart.

In another embodiment, AS 14 automatically initiates the electronic transaction responsive to detecting that communication with the customer have either failed or will imminently fail. In more detail, customers in store 30 are associated with respective mobile devices 20a (e.g., a SMARTPHONE) and 20b (e.g., a tablet device). The mobile devices 20a, may be the customer's personal devices or may be provided by the store 30. Upon entry into store 30, a communications link (e.g., a WiFi link) is established between the mobile devices 20a, 20b and AS 14 and maintained while the customer moves throughout store 30. As the customer selects an item for purchase (e.g., by removing the item from a shelf), cameras 32 capture an image of the customer interacting with the item and sends the image to AS 14. AS 14 then analyzes the images. Based on the analysis, AS 14 identifies the item selected by the customer and determines whether the customer has removed the item from availability for purchase by others. AS 14 then adds the item to a list of purchased items purchased by the customer.

In one embodiment, for example, there are two lists maintained at one or both of AS 14 and mobile devices 20a, 20b. If the customer selected an item from a preauthorized charging zone 34 or otherwise removed the item from availability for purchase by others, AS 14 automatically initiates the electronic transaction to debit the customer's financial account for the cost of the item and places the item on a “purchased” list. If, however, the customer did not select an item from a preauthorized charging zone 34, or remove the item from availability for purchase by others, AS 14 simply places the item on a “pending” list. The pending list identifies the items the customer has selected for purchase but has not yet paid for.

Generally, AS 14 will initiate a subsequent electronic transaction to debit the customer's financial account for the cost of the items on the “pending” list when the customer exits the store 30. However, in at least one embodiment, AS 14 is configured to initiate the subsequent electronic transaction for the cost of the items currently on the “pending” list prior to the customer checking out of store 30 upon detecting that it can no longer communicate with the mobile devices 20a, 20b, or that a loss of communications with the mobile devices 20a, 20b is imminent due, for example, to a failing power source of mobile devices 20a, 20b (e.g., a dead or dying battery).

As stated above, a digital image analysis is performed on the images captured by cameras 32, the results of which provide various data points. For example, one such data point is the location of the customer in store 30 relative to zones 34, 36. Other data points include, but are not limited to, the identity of the customer, the item being selected by the customer, and whether the customer has/has not effectively removed the item from purchase by other customers in store 30. Regardless, the digital image analysis of the captured digital images is performed by a computer such as AS 14. That is, the digital image analysis of the present embodiments comprises a digital processing technique in which AS 14 transforms the captured digital images into data (e.g., a series of pixels or numbers) so that it can analyze that data. Then, based on the transformed data, AS 14 can extract meaningful information.

For example, AS 14 may utilize any of a plurality of known face recognition algorithms to identify the customer. One such method is the OpenCV method. With this method, a computer such as AS 14 first extracts the “Haar features” from the image into a large sample set. As is known in the art, Haar features are digital image features used in object recognition software. An “Adaptive Boosting” algorithm (commonly referred to as an “AdaBoost” algorithm) is then used to detect the face of the customer.

Additionally, AS 14 may execute any of a plurality of known edge detection algorithms, pattern recognition algorithms, digital geometry algorithms, 2D and/or 3D object recognition algorithms, video tracking algorithms, and signal processing techniques to identify items selected by the customer and/or to identify a location of the customer in store 30. Moreover, these same techniques, and as well as other known computer-implemented digital processing techniques, may be used by AS 14 to determine whether the customer has effectively removed an item from purchase by other customers in store 30. For example, based on the results of the analysis, AS 14 may determine that the customer has at least partially consumed the item (e.g., some cookies out of a package of cookies). In another embodiment, AS 14 may determine that the customer has opened the packaging of an item.

Other examples of some of the digital image processing techniques suitable for use with the present embodiments include, but are not limited to, bar code and QR code reader algorithms, error diffusion algorithms, and dithering algorithms. In some embodiments, deep learning algorithms such as the well-known convolutional neural networks (CNNs) are utilized to identify objects in the captured digital images and increase the accuracy of the digital image analysis results.

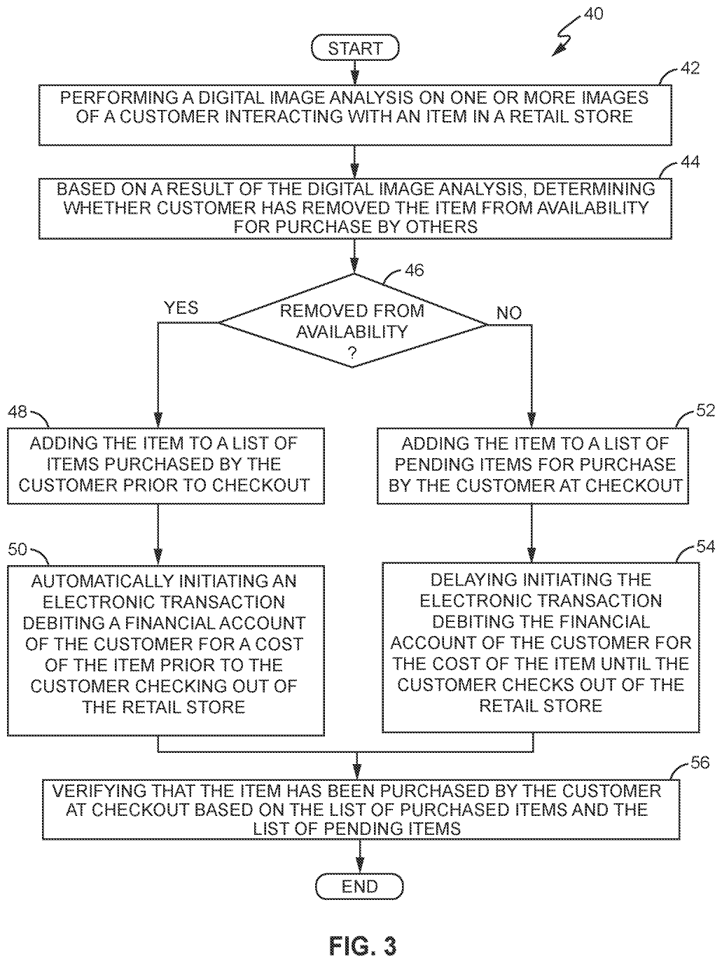

FIG. 3 is a flow diagram illustrating a method 40 for initiating an electronic transaction for an item that a customer has effectively removed from availability for purchase by others, according to one embodiment of the present disclosure. In this embodiment, method 40 is implemented by AS 14; however, as those of ordinary skill in the art will readily appreciate, this is merely for illustrative purposes. Method 40 of FIG. 3 may be implemented by a computing device other than AS 14, or in a distributed environment by one or more computing devices such as AS 14.

As seen in FIG. 3, method 40 begins with AS 14 performing a digital image analysis on one or more digital images of a customer interacting with an item in a retail store (box 42). The digital images on which the analysis is based are provided, in this embodiment, by cameras 32. Based on a result of the digital image analysis, AS 14 determines whether the customer has removed the item from availability for purchase by others (box 44). If AS 14 determines that the customer has removed the item from availability for purchase by others (box 46), AS 14 adds the item to a list of items that have been purchased by the customer prior to checkout (box 48) and automatically initiates an electronic transaction debiting a financial account of the customer for the cost of the item prior to the customer checking out of store 30 (box 50). If AS 14 determines that the customer has not removed the item from availability for purchase by others (box 46), AS 14 adds the item to a list of items that are pending purchase by the customer at check out (box 52) and delays initiating the electronic transaction debiting the financial account of the customer for the cost of the items until the customer checks out of store 30 (box 54). At check out, AS 14 verifies that the items already purchased by the customer (i.e., those items added to the list of purchased items) do not appear on the list of “pending” items, and that the items on the pending list do not appear on the list of items already purchased by the customer (box 56). AS 14 can then initiate the electronic transaction to debit the customer's financial account for the cost of the items on the list of pending items. In this manner, AS 14 can ensure that the customer has paid for all of the selected items.

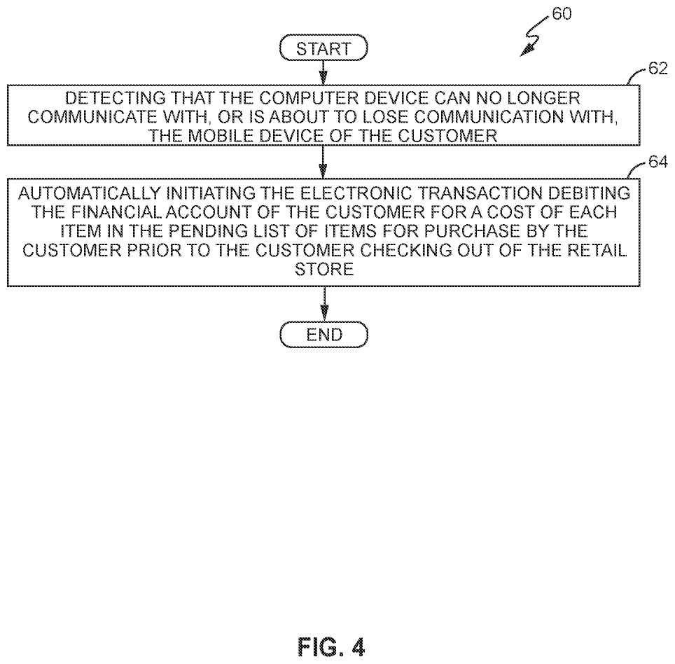

As previously stated, AS 14 need not initiate the electronic transaction to debit the customer's financial account only upon determining that the customer has effectively removed the item from availability for purchase by others. Rather, AS 14 is also configured to initiate such a transaction responsive to detecting other trigger events. FIG. 4, for example, is a flow diagram illustrating a method 60 for initiating an electronic transaction for an item that a customer has effectively removed from availability for purchase by others, based on a detected trigger event according to one embodiment of the present disclosure.

As seen in FIG. 4, method 60 begins with AS 14 detecting that it can no longer communicate with, or is about to lose communications with, a mobile device, such as mobile device 20a, via the previously established communications link (box 62). Such a loss of communications may be caused by a dead or dying battery, for example. Responsive to the detection, AS 14 automatically initiates the electronic transaction to debit the customer's financial account for the cost of all items on the “pending” list prior to the customer checking out of store 30 (box 64). This allows the retailer to at least receive customer payment for any “as-yet-unpaid-for” items selected by the customer under certain circumstances.

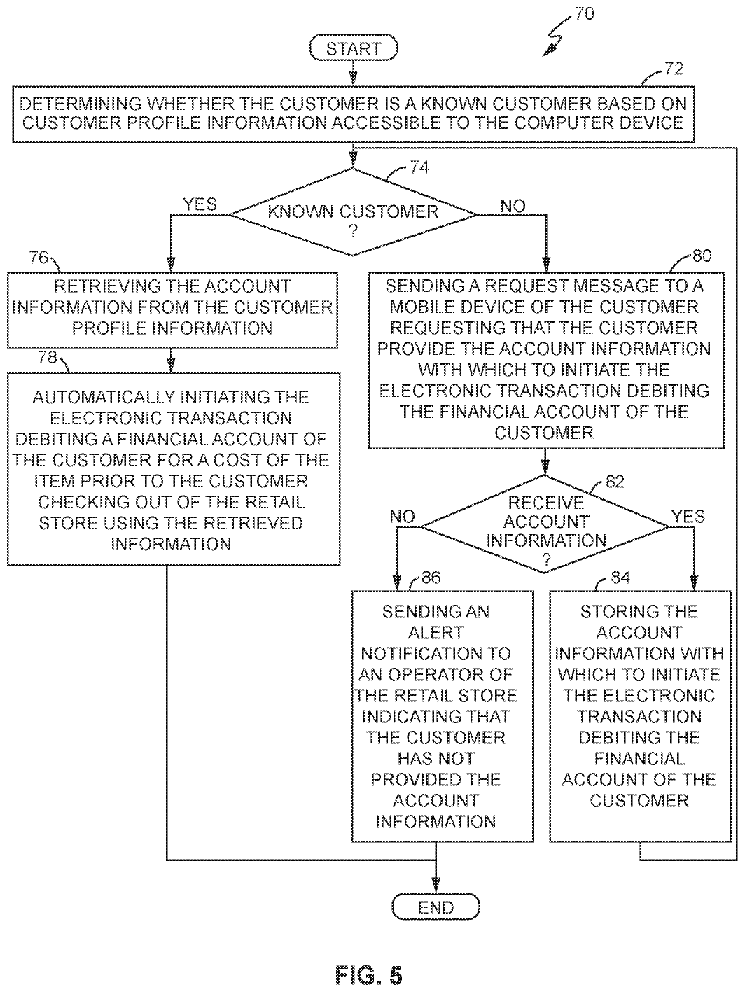

According to the present embodiments, a customer should pre-authorize AS 14 to charge the customer's financial accounts for the cost of an item prior to entering the store. Such information may be stored and maintained, for example, in a customer profile on DB 16. FIG. 5 is a flow diagram illustrating a method 70 for obtaining the information required to initiate the electronic transaction for the items a customer has effectively removed from availability for purchase by others, according to one embodiment of the present disclosure.

As seen in FIG. 5, AS 14 first determines whether a customer is known to store 30 based on the profile information available to it (box 72). By way of example only, one or more images of a customer are captured by the cameras 32 when the customer enters store 30. AS 14 then performs a facial recognition technique, as previously descried, to identify the customer. If AS 14 identifies the customer as a known customer (box 74), As 14 retrieves the customer's financial account information from the customer's profile (box 76). Then, responsive to detecting that the customer has effectively removed an item for purchase by others, or in response to detecting a predetermined trigger event, AS 14 automatically initiates the electronic transaction debiting the financial account of the customer for the items using the retrieved financial account information (box 78).

However, if AS 14 does not identify the customer as a known customer (box 74), AS 14 generates and sends a message (e.g., a text message) to the customer's mobile device requesting that the customer provide the financial account information (box 80). If the customer provides the requisite financial account information (box 82), AS 14 generates a customer profile and stores the information in the newly-created customer profile (box 84). If the customer does not provide the requisite financial account information (box 82), AS 14 generates and sends an alert message to an operator of store 30 indicating that the customer is unknown and has not provided the details required for automatically debiting the customer's financial account (box 86). In these cases, the store operator may perform a manual inspection of the items in the customer's cart.

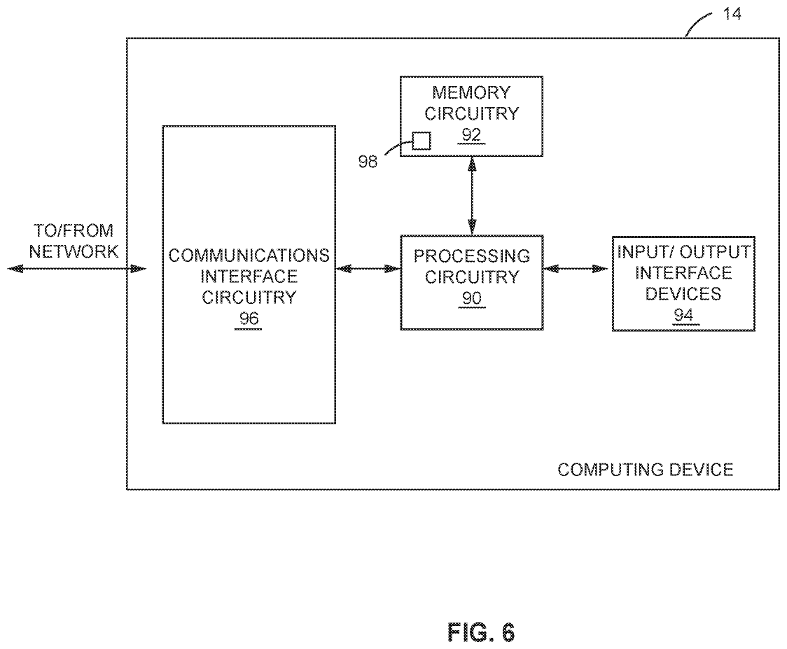

FIG. 6 is schematic block diagram illustrating some component parts of a computing device (e.g., AS 14) configured to initiate an electronic transaction for an item that a customer has effectively removed from availability for purchase by others, according to one embodiment of the present disclosure. As seen in FIG. 6, AS 14 comprises processing circuitry (i.e., controller) 90, memory circuitry 92, one or more input/output interface devices 94, and communications interface circuitry 96.

Processing circuitry 90 comprises one or more microprocessors, hardware circuits, firmware or a combination thereof. In the exemplary embodiments described herein, processing circuitry 90 is configured to control the functions of AS 14 according to instructions and data stored in memory circuitry 92. Additionally, however, processing circuitry 90 is configured to implement the methods of the previously described embodiments. Particularly, as stated above, processing circuitry 90 is configured to determine whether a customer has removed an item from availability for purchase by others based on the results of a digital image analysis performed on one or more digital images of the customer interacting with the item. Then, based on that determination, processing circuitry 90 is configured to either automatically initiate an electronic transaction debiting a financial account of the customer for a cost of the item prior to the customer checking out of the retail store, or delay initiating that transaction until the customer checks out of the store 30.

Memory circuitry 92 comprises a non-transitory computer readable medium that stores executable program code and data used by processing circuitry 90 for operation. In this embodiment, the program code and data comprises a control program 98 that, when executed by processing circuitry 90, configures AS 14 to perform the functions previously described. In some embodiments, control program 98 has access to information and data that can be utilized by processing circuitry 90 to identify items selected by the customer, determine whether the customer has effectively removed the item form purchase by others, and if so, to automatically initiate a transaction to debit the customer's financial account for the cost of that item, as previously described. Memory circuitry 92 may include both volatile and non-volatile memory, and may comprise random access memory (RAM), read-only memory (ROM), and electrically erasable programmable ROM (EEPROM) and/or flash memory. Additionally or alternatively, memory circuitry 92 may comprise discrete memory devices, or be integrated with one or more microprocessors in the processing circuitry 90.

The input/output (I/O) devices 94 of AS 14 may comprise, for example, a keyboard, mouse, and/or any other device a user can utilize to interact with AS 14. The communications interface circuitry 96 comprises, in one embodiment, a transceiver circuit and/or interface circuit for communicating with remote devices over a communication network or direct communication link. For example, the communications interface circuitry 96 may comprise a WiFi interface, a cellular radio interface, a BLUETOOTH interface, an Ethernet interface, or other similar interface for communicating over communications network 12 and/or a wireless communication link. AS 14 may use the communications interface circuitry 96, for example, to communicate with one or more other computing devices (e.g., POS station(s) 18, mobile device(s) 20a, 20b, and/or DB 16), as previously described.

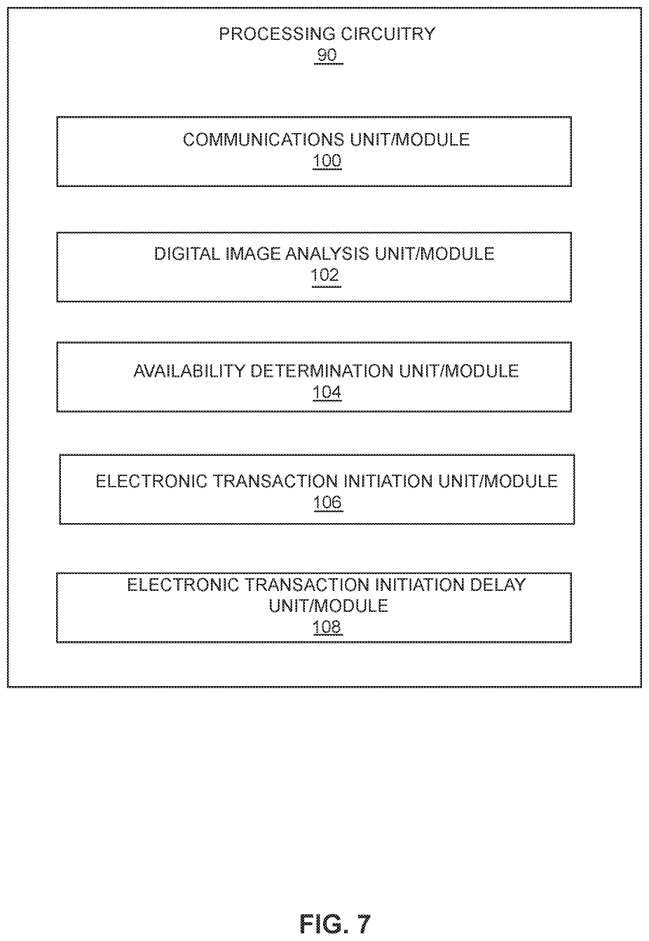

FIG. 7 is a schematic block diagram of a computer program product (e.g., control program 98) that when executed by processing circuitry 90, configures a computing device such as AS 14 to automatically initiate an electronic transaction for an item that a customer has effectively removed from availability for purchase by others, according to one embodiment of the present disclosure.

As seen in FIG. 7, control program 98 executes on processing circuitry 90 and comprises a communications unit/module 100, a digital image analysis unit/module 102, an item availability determination unit/module 104, an electronic transaction initiation unit/module 106, and an electronic transaction initiation delay unit/module 108.

The communications unit/module 100 comprises program code that is executed by processing circuitry 90 to facilitate the communication of signals and data with one or more remotely located devices via communications network 12, as previously described.

The digital image analysis unit/module 102 comprises program code that is executed by processing circuitry 90 to implement a digital image analysis according to any of the previously identified digital image processing algorithms, or according to any digital image processing algorithm, as previously described.

The item availability determination unit/module 104 comprises program code that is executed by processing circuitry 90 to determine whether a customer has effectively removed an item from availability for purchase by others, as previously described. The determination, as described above, is based at least in part on the results of the digital image analysis performed by the digital image analysis unit/module 102, as previously described.

The electronic transaction initiation unit/module 106 comprises program code that is executed by processing circuitry 90 to automatically initiate an electronic transaction to debit the customer's financial account for the cost of an item that he/she has effectively removed an item from availability for purchase by others, as previously described.

The electronic transaction initiation delay unit/module 108 comprises program code that is executed by processing circuitry 90 to delay the automatically initiation of an electronic transaction to debit the customer's financial account for the cost of an item that, as previously described. Both the electronic transaction initiation unit/module 106 and the electronic transaction initiation delay unit/module 108 implement their respective functions based, at least in part, on information and data provided by item availability determination unit/module 104, as previously described.

The present embodiments may, of course, be carried out in other ways than those specifically set forth herein without departing from essential characteristics of the invention. For example, the previous embodiments illustrate AS 14 as the physical entity performing the digital image analysis. However, this is merely for ease of discussion. As those of ordinary skill in the art will readily appreciate, the present embodiments may exist in a distributed environment. Therefore, one or more computing devices other than AS 14 may perform the digital image analysis and provide the results to AS 14 for further processing.

Additionally, the present embodiments utilize the financial details of the customer in order to automatically charge the customer's financial account for the items he/she effectively removes from availability for purchase by others. The financial details may include the customer's bank account number(s), for example, and may be implemented using any existing pay technology known in the art including, but not limited to, GOOGLEPAY and APPLEPAY.

Further, the previous embodiments identify items some human behaviors that qualify an item as having been effectively removed from availability for purchase by others. For example, AS 14 may determine that the consumer is consuming an edible item. However, those of ordinary skill in the art should appreciate that this is merely illustrative, and that the present embodiments are also configured to recognize other such behaviors and gestures and initiate an electronic transaction charging the customer's financial account accordingly.

By way of example only, AS 14 may analyze the captured images using any of a variety of known computer vision and image processing techniques to determine whether the customer is eating a selected item, adding a small item to a basket or cart, and/or simply walking around the store while holing a high-cost item (e.g., electronics, jewelry, etc.) or other small, easily concealable item. For example, in one embodiment, AS 14 is configured to analyze a plurality of frame-by-frame images captured by cameras 32 to determine the customer's hand placement/position, motion, and the like. Based on the results of the analysis, AS 14 could be controlled to initiate an electronic transaction debiting the financial account of the customer for the cost of the item, as previously described. Some examples of well-known computer vision and image processing techniques that can be used by AS 14 include, but are not limited to, 3D model-based algorithms (e.g., volumetric and/or skeletal models that create 3D surfaces from polygon meshes), skeletal-based algorithms (e.g., algorithms that create and analyze the position and movement of a “virtual” skeleton of the customer), and appearance-based models.

The embodiments of the present disclosure may utilize any of these computer-based techniques to perform the digital image analysis of the digital images captured by cameras 32. However, other computer-based vision and processing techniques, although not specifically identified here, are also suitable for use with the present embodiments. Regardless, according to the present disclosure, the results of the digital image analysis are used to control a computer, such as AS 14, to make the determination on whether a customer has or has not removed an item from availability for purchase by others, and thereafter automatically initiate, or delay initiating, the electronic transaction debiting a financial account of the customer for the cost of the item, as previously described.

Therefore, the present embodiments are to be considered in all respects as illustrative and not restrictive, and all changes coming within the meaning and equivalency range of the appended claims are intended to be embraced therein.

What is claimed is:

1. A method, implemented by a computer device, for charging retail customers for an item, the method comprising:
performing a digital image analysis on one or more images of a user interacting with an item in a retail store, wherein the one or more images are captured by one or more cameras disposed in the retail store;
based on a result of the digital image analysis, determining whether the user has removed the item from availability for purchase by others;
responsive to determining that the user has removed the item from availability for purchase by others, automatically initiating an electronic transaction debiting a financial account of the user for a cost of the item prior to the user checking out of the retail store; and
responsive to determining that the user has not removed the item from availability for purchase by others, delaying initiating the electronic transaction debiting the financial account of the user for the cost of the item until the user checks out of the retail store.

2. The method of claim 1 further comprising:
adding the item to a list of purchased items purchased by the user prior to checkout responsive to determining that the user has removed the item from availability for purchase by others; and
adding the item to a list of pending items for purchase by the user at checkout responsive to determining that the user has not removed the item from availability for purchase by others.

3. The method of claim 2 further comprising verifying that the item has been purchased by the user at checkout based on the list of purchased items and the list of pending items.

4. The method of claim 2 wherein the computer device is in communication with a mobile device of the user via a communication link established with the mobile device of the user, the method further comprising:
detecting that the computer device can no longer communicate with, or is about to lose communications with, the mobile device of the user; and
automatically initiating the electronic transaction debiting the financial account of the user for a cost of each item in the pending list of items for purchase by the user prior to the user checking out of the retail store.

5. The method of claim 1 further comprising obtaining account information for the user with which to initiate the electronic transaction debiting the financial account of the user.

6. The method of claim 5 wherein obtaining the account information for the user comprises:
determining whether the user is a known user based on user profile information accessible to the computer device;
responsive to determining that the user is a known user, retrieving the account information from the user profile information; and
responsive to determining that the user is not a known user, sending a request message to a mobile device of the user requesting that the user provide the account information with which to initiate the electronic transaction debiting the financial account of the user.

7. The method of claim 6 further comprising:
responsive to receiving the account information from the user, storing the account information with which to initiate the electronic transaction debiting the financial account of the user in a memory; and
responsive to not receiving the account information from the user, sending an alert notification to an operator of the retail store indicating that the user has not provided the account information, the alert notification comprising one or more of:
a location of the user in the retail store;
a first digital image of the item that the user has removed from availability for purchase by others; and
a second digital image of the user, wherein one or both of the first and second images are captured by the one or more cameras disposed in the retail store.

8. The method of claim 1 wherein the retail store is partitioned into a plurality of zones, and wherein each zone comprises a plurality of different items available for purchase by the user and is designated as being one of a preauthorized charging zone and a non-preauthorized charging zone.

9. The method of claim 8 wherein the electronic transaction debiting the financial account of the user for the cost of the item prior to the user checking out of the retail store is automatically initiated responsive to determining that the user selected the item from a zone designated as a preauthorized charging zone.

10. The method of claim 1 further comprising initiating a subsequent electronic transaction crediting the financial account of the user for the cost of the item responsive to determining that the user has replaced the item such that the item is again available for purchase by others.

11. The method of claim 10 wherein the subsequent electronic transaction crediting the financial account of the user for the cost of the item is dependent on a type of the item.

12. A computing device for charging retail customers for an item, the computing device comprising:
communications interface circuitry configured to communicate data with a computer network; and
processing circuitry operatively connected to the communications interface circuitry and configured to:
perform a digital image analysis on one or more images of a user interacting with an item in a retail store, wherein the one or more images are captured by one or more cameras disposed in the retail store;
based on a result of the digital image analysis, determine whether the user has removed the item from availability for purchase by others;
responsive to determining that the user has removed the item from availability for purchase by others, automatically initiate an electronic transaction debiting a financial account of the user for a cost of the item prior to the user checking out of the retail store; and
responsive to determining that the user has not removed the item from availability for purchase by others, delay initiating the electronic transaction debiting the financial account of the user for the cost of the item until the user checks out of the retail store.

13. The computing device of claim 12 wherein the processing circuitry is further configured to:
add the item to a list of purchased items purchased by the user prior to checkout responsive to determining that the user has removed the item from availability for purchase by others; and
add the item to a list of pending items for purchase by the user at checkout responsive to determining that the user has not removed the item from availability for purchase by others.

14. The computing device of claim 13 wherein the computer device is in communication with a mobile device of the user via a communication link established with the mobile device of the user, and wherein the processing circuitry is further configured to:
detect that the computer device can no longer communicate with, or is about to lose communications with, the mobile device of the user; and
automatically initiate the electronic transaction debiting the financial account of the user for a cost of each item in the pending list of items for purchase by the user prior to the user checking out of the retail store.

15. The computing device of claim 12 wherein the processing circuitry is further configured to:
determine whether the user is a known user based on user profile information accessible to the computer device;
responsive to determining that the user is a known user, retrieve the account information from the user profile information; and
responsive to determining that the user is not a known user, send a request message to a mobile device of the user requesting that the user provide the account information with which to initiate the electronic transaction debiting the financial account of the user.

16. The computing device of claim 15 wherein the processing circuitry is further configured to:
responsive to receiving the account information from the user, store the account information with which to initiate the electronic transaction debiting the financial account of the user in a memory; and
responsive to not receiving the account information from the user, send an alert notification to an operator of the retail store indicating that the user has not provided the account information, the alert notification comprising one or more of:
a location of the user in the retail store;
a first digital image of the item that the user has removed from availability for purchase by others; and
a second digital image of the user, wherein one or both of the first and second images are captured by the one or more cameras disposed in the retail store.

17. The computing device of claim 12 wherein the retail store is partitioned into a plurality of zones with each zone comprising a plurality of different items available for purchase by the user and designated as being one of a preauthorized charging zone and a non-preauthorized charging zone.

18. The computing device of claim 17 wherein the processing circuitry is further configured to automatically initiate the electronic transaction responsive to determining that the user selected the item from a zone designated as a preauthorized charging zone.

19. The computing device of claim 12 wherein the processing circuitry is further configured to initiate a subsequent electronic transaction crediting the financial account of the user for the cost of the item responsive to determining that the user has replaced the item such that the item is again available for purchase by others.

20. A non-transitory computer readable medium comprising instructions stored thereon that, when executed by processing circuitry of a computing device, causes the computing device to:
perform a digital image analysis on one or more images of a user interacting with an item in a retail store, wherein the one or more images are captured by one or more cameras disposed in the retail store;
based on a result of the digital image analysis, determine whether the user has removed the item from availability for purchase by others;
responsive to determining that the user has removed the item from availability for purchase by others, automatically initiate an electronic transaction debiting a financial account of the user for a cost of the item prior to the user checking out of the retail store; and
responsive to determining that the user has not removed the item from availability for purchase by others, delay initiating the electronic transaction debiting the financial account of the user for the cost of the item until the user checks out of the retail store.
